(19) United States
(12) Patent Application Publication
(10) Pub. No.: US 2016/0271837 A1
(43) Pub. Date: Sep. 22, 2016

(54) DEVICE AND METHOD FOR CLEANING PLASTIC IN THE COURSE OF PLASTIC RECYCLING

(71) Applicant: CVP CLEAN VALUE PLASTIC GMBH, Buxtehude (DE)

(72) Inventors: Alexander Gercke, Bad Oldesloe (DE); Carsten Wermter, Hamburg (DE); Michael Hofmann, Hamburg (DE)

(21) Appl. No.: 15/029,446

(22) PCT Filed: Oct. 7, 2014
(86) PCT No.: PCT/EP2014/071444

§ 371 Date: Apr. 14, 2016

(30) Foreign Application Priority Data
Oct. 15, 2013 (DE) 10 2013 111 365.6

(51) Int. Cl. B29B 17/02; B08B 1/00; B08B 7/00; B08B 3/04; B08B 3/10; B08B 1/04; B08B 1/02

(52) U.S. Cl. CPC B29B 17/02; B08B 1/04; B08B 1/001; B08B 1/02; B08B 3/041; B08B 3/10; B08B 7/0064; B29B 2017/0217; Y02W 30/622

(57) ABSTRACT

A device for cleaning plastic includes a housing, a first refiner tool disposed within the housing and a second refiner tool disposed within the housing and a second refiner tool configured to face the first refiner tool. A working gap is defined between the two refiner tools and connected to an inlet opening and an outlet. The refiner tools are configured to rub cellulose and other adhering materials off of the plastic that is fed into the working gap through the inlet opening and expelled through the outlet.

### CROSS REFERENCE TO RELATED APPLICATIONS

This application is a national stage application under 35 U.S.C. §371 of International Application No. PCT/EP2014/071444, filed Oct. 7, 2014, which claims priority to German Patent Application No. 10 2013 111 365.6, filed Oct. 15, 2013, the entire contents of each application being herein incorporated by reference.

### BACKGROUND OF THE INVENTION

The invention relates to a device for cleaning plastic, in particular shredded plastic, in the course of plastic recycling, comprising a refiner having two refiner tools facing each other, of which at least one is rotationally driven, and which delimit a working gap between each other for rubbing cellulose and other adhering materials off the plastic, wherein the refiner has an inlet that opens into the working gap, further comprising an input apparatus connected to the inlet, for inputting the plastic to be cleaned into the inlet, and wherein the refiner has an outlet, which is likewise connected to the working gap and through which the cleaned plastic in the working gap is led away to an exit together with the rubbed-off cellulose and other adhering materials.

The invention further relates to a method for cleaning plastic, in particular shredded plastic, in the course of plastic recycling in a refiner having two refiner tools facing each other, of which at least one is rotationally driven, and which delimit a working gap between each other, wherein the plastic to be cleaned is input into the working gap, cellulose and other adhering materials are rubbed off the plastic in the working gap, and the cleaned plastic together with the rubbed-off cellulose and other adhering materials is then led away from the working gap to an exit via an outlet.

Shredded plastic, for example, so-called flakes are cleaned of cellulose and other adhering materials in refiners, for example disc refiners, by the addition of water, in particular by friction between the refiners facing each other. A separation apparatus is often attached to the disc refiner, in which the shredded plastic is separated from the rubbed-off contaminations. In this process the consistency of the suspension, which is made out of water and plastic to be cleaned, and processed in the disc refiner, is an important parameter. In the paper industry disc refiners are usually operated with low (or thin) consistency, that is, the solid content in the suspension is below 3% by weight as a rule. One reason is the lack of pumpability of suspensions with consistencies of more than 3% by weight, in particular with cellulose or fibres. Only in atmospherically operated disc refiners with a pump sump is operation with a high (or thick) consistency possible under very strict conditions or it is avoided by means of a pressure operation with water vapour. With plastic film shreds, besides the problems already explained, additional problems with floating to the top or respectively problems with sinking occur. Plastic films in particular have a strong tendency to float to the top due to their low density and to the preferred plastic, PE-LD, so that atmospheric operation of the disc refiner via a normal pump sump is no longer possible practically or respectively economically.

However, with hydrodynamic operation with a low consistency as an alternative to atmospheric operation with high consistency, a large pump sump can be dispensed with. Also, the additional problems of atmospheric operation already explained are avoided. However, the friction in the working gap and therefore the cleaning effect with a low consistency of the suspension is less. An additional important criterion for operation is energy consumption. Energy consumption is significantly determined by the consistency of the suspension in the working gap of the disc refiner. On entering the working gap the water-solid suspension is greatly accelerated, which requires a great deal of energy. The greater the water quantity which has to be accelerated between the working discs, the higher the energy requirement of the cleaning process. The energy consumption depends on a plurality of parameters, such as the space between the discs, the disc geometry, water volume and consistency of the solids. With materials with a low bulk density, such as plastic films (bulk density 40-100 kg/m3 or less), and a correspondingly high volume, the conveyability or respectively pumpability of the suspension is the crucial criterion for how high the consistency of the solids can be. For example, with plastic film shreds 40 m×40 mm in size and with a bulk density of approx. 60 kg/m3 a maximum solid consistency of 2-2.5% by weight of the suspension is possible for the suspension to remain pumpable. This is linked to a very high water content which is not at all necessary for cleaning the film shreds, but does lead to a marked increase in energy consumption.

Proceeding from the state of the art explained, the object of the invention is to provide a device and a method of the type mentioned at the outset, with which an efficient and highly effective cleaning of plastic is achieved in a structurally simple manner.

### BRIEF SUMMARY OF THE INVENTION

For a device of the type mentioned at the outset, the invention achieves the object in that the outlet comprises an outlet pipe, which is connected to the working gap and leads to the exit, wherein the outlet pipe is connected to a water pump for pumping water through the outlet pipe, wherein during operation the water pumped through the outlet pipe by means of the water pump has a suction effect on the working gap in such a way that cleaned plastic is conveyed from the working gap into the outlet pipe, and wherein the water pumped through the outlet pipe by means of the water pump conveys or causes the plastic located in the working gap to the exit.

For a method of the type mentioned at the outset the invention achieves the object in that water is pumped through an outlet pipe, which is connected to the working gap and leads to the exit, by means of a water pump, wherein the water pumped through the outlet pipe has a suction effect on the working gap in such a way that cleaned plastic is conveyed from the working gap into the outlet pipe and conveyed to the exit with the water pumped through the outlet pipe.

The plastic to be cleaned according to the invention is in particular waste plastic to be recycled. In particular it can be pre-crushed shredded plastic, so-called plastic flakes. The shredded plastic can again be plastic film shreds. The plastic to be cleaned is conveyed through the input apparatus into the working gap of the disc refiner via the inlet. The plastic can be supplied to the working gap by the input apparatus together with water. However, a dry supply of the plastic for example is also possible if, for example, a screw conveyor of the input apparatus has a hollow pipe as the core, through which water is introduced to adjust the cleaning consistency in the working gap. In this case the input consistency before reaching the working gap would be 100% solids. A supply with (water) vapour is also possible, in particular in the case of a vapour-driven pressure refiner. The working gap is delimited by the work surfaces of the refiner tools, which face each other. Suitable friction members are arranged on the work surfaces. At least one of the refiner tools is rotationally driven (rotor). The other refiner tool can likewise be rotationally driven or it can stand fixed (stator). In the case of a disc refiner for example, with which the refiner tools are refiner discs, the work surfaces of the refiner discs which face each other can be formed circular or respectively ring-shaped. Accordingly, a circular or respectively ring-shaped working gap is formed in the plan view. The suspension made of plastic to be cleaned and water, which is introduced into the working gap, is accelerated rotationally by the rotation of at least one refiner tool, and contaminations, such as cellulose or other adhering materials, are rubbed off the plastic. Together with the rubbed-off contaminations and the water, the plastic in the working gap is transported to an outlet of the refiner by means of the rotational acceleration of the suspension. The outlet comprises an outlet opening, which communicates with the working gap in particular laterally and to which an outlet pipe, which runs in particular tangentially, at least in sections, in particular completely tangentially, relative to the working gap. The outlet pipe can in particular be connected to the lateral outlet opening of the working gap in tangential direction. Together with the rubbed-off contaminations and the water, the cleaned plastic is conveyed to the exit via the outlet pipe. The exit can be connected to a separation apparatus in which the cleaned plastic is separated from the rubbed-off contaminations. The separation apparatus can be formed in a known manner. For example, it can be a float-sink separation apparatus, a sieve separation apparatus with a sieve basket for example, or the like. Moreover, the exit can, for example, lead to an additional refiner of an additional cleaning stage.

According to the invention, the outlet pipe is further connected to a water pump, which pumps additional water through the outlet pipe in the direction of the exit. The water jet, which is pumped through the outlet pipe and in particular directed, flows through the outlet pipe in particular tangentially past the working gap, in particular the lateral outlet opening of the working gap. The water is conveyed via a water inlet opening into the outlet pipe by the water pump. The water inlet opening can be arranged on the side of the outlet pipe, which faces away from the exit. The water jet generated according to the invention, which flows laterally past the working gap and is in particular tangential relative to the working gap, fulfils two important functions. On the one hand, the water jet transports the suspension which is conveyed from the working gap into the outlet pipe, to the exit. In this case at least a part of the suspension can already have been conveyed from the working gap into the outlet pipe due to centrifugal force. Furthermore, the directed water jet does create a suction effect in the working gap, which at least enhances the transport from the working gap into the outlet pipe. The suspension located in the outlet pipe is conveyed to the exit together with the directed water jet. Hence the water pump provided according to the invention works according to the principle of a jet pump or respectively a water-jet pump. As with a venturi nozzle, a low pressure is generated, which sucks the suspension located in the working gap into the outlet pipe. This enhances the tangential automatic discharge of the cleaned plastic from the working gap.

Another important function of the water pump arrangement provided according to the invention is the possibility of being able to adjust the output consistency independently of the cleaning consistency. The cleaning consistency describes the ratio of solids to water in the working gap. The output consistency describes the ratio of solids to water in the outlet from the working gap accordingly. Accordingly, the input consistency describes the ratio of solids to water at the inlet of the working gap, in particular in the direction of the input. The possibility of being able to adjust the output consistency independently of the cleaning consistency enables the resolution of the target conflict explained at the outset. In terms of maximum energy efficiency and cleaning effect it is possible according to the invention, to set a high solid consistency in the working gap and, at the same time, to set an easily conveyable or respectively pumpable suspension with a low consistency following the working gap. This is possible according to the invention in a structurally particularly simple and compact manner. In this case flexible selection of the best respective consistency setting for the processed raw materials is possible, for example for bulky raw materials with a low bulk density, such as plastic film shreds. Moreover, the rinsing capacity of the contaminations rubbed off via friction can be improved and a particularly homogeneous, easily conveyable suspension created in the outlet. Since the water jet guided past the working gap according to the invention does not enter the working gap, the cleaning consistency is not influenced in an undesired manner. A pump sump or respectively a solids handling pump for discharging the suspension is not required according to the invention. A particularly compact structure is achieved thereby.

According to one embodiment the outlet pipe can be extended in its cross-section in the direction of the working gap to the exit. Hence a diffuser is formed, which improves the discharge of the cleaned plastic.

According to a further embodiment a nozzle can be arranged in or on the outlet pipe, or the outlet pipe itself can act as a nozzle, whereby the nozzle effect of a respective directed water jet is created in the outlet pipe, in particular in tangential direction relative to the working gap. A nozzle pipe acting as a nozzle can be inserted into the outlet pipe at an end of the outlet pipe connected to the water pump. The nozzle pipe can be arranged as movable in longitudinal direction in the outlet pipe and/or the nozzle pipe can be arranged as tippable in the outlet pipe. Furthermore, the nozzle pipe can be releasably attached in or on the outlet pipe. By providing a suitable nozzle, a directed water jet is generated in the outlet pipe in a particularly easy manner. This improves the discharge and the suction effect and reliably prevents an undesired injection of water into the working gap. To form a sufficiently directed water jet may require the nozzle to project into the outlet pipe. However, then it comes into contact with the cleaned plastic and the rubbed-off contaminations, so that wear of the nozzle occurs with abrasive plastics, such as PET, for example. In such a case it is favourable for the nozzle pipe to be releasably attached in or on the outlet pipe, since it can then be replaced easily. As long as the nozzle pipe is movable, for example movable in longitudinal direction and/or adjustable in its longitudinal direction at a changeable angle relative to the longitudinal direction of the outlet pipe, the directed water jet can be controlled in a targeted manner. Also conceivable is for the nozzle pipe to have a changeable nozzle opening, so that the output speed and/or the spray cone of the water jet exiting the nozzle pipe can be adjusted.

The refiner can be a disc refiner, in particular a toothed disc refiner. The refiner tools are then formed by refiner discs. Teeth, which remove cellulose and other adhering materials from the plastic to be cleaned by friction, are then arranged in a known manner on the work surfaces which face each other and delimit the working gap. The inlet can then open into the working gap in axial direction of the refiner discs. It can, for example, open centrally into the working gap, in axial direction of the working discs, which at the same time forms the axis of rotation of the at least one rotationally driven refiner disc, where it can input the suspension made of plastic to be cleaned and water. However the refiner can also be a conical refiner or a drum refiner.

The input apparatus can, in a particularly feasible manner, comprise a screw conveyor. Also, screw conveyors can convey high consistency suspensions reliably and effectively.

Furthermore, the input apparatus can comprise a water supply apparatus through which water can be directly supplied to the input apparatus. Therefore, water can, for example, be injected directly into the screw flight of a screw conveyor. However, the water can also be injected, for example, shortly before the screw flight of a screw conveyor. This embodiment enables adjustment of the input consistency before entry into the working gap. Consequently, a targeted pre-wetting by water of the plastic, which is to be cleaned is also possible via screw conveyors during the high consistency input of solids, without an agitator with a pump input, for example a vat with a stir agitator, being required. Also conceivable is a mix input, during which material is chipped from a solids handling pump and then input into the inlet via a screw conveyor. Further conceivable are input apparatuses with special pumps for high consistency operation.

According to a further embodiment a water supply apparatus can be assigned to the working gap of the refiner, through which water can be supplied directly into the working gap of the refiner. In addition, one or a plurality of water inlets, for example nozzles, can be provided in one of the refiner tools, for example the non-rotated stator. In this way the cleaning consistency can be reduced in the working gap independently of the input consistency. The transport of the material can be assisted by an improvement in the flow behaviour in the working gap. This also enables in turn the formation of complex work surfaces of the refiner tools. The targeted addition of water into the working gap in certain positions can improve the transport of the material in such a way that an enlargement of the surfaces of the work surfaces delimiting the working gap is achieved by means of more complex work surface geometries. This leads in turn to a more efficient cleaning effect and a higher throughput. Targeted water injection, for example via the stator of the refiner, can also favour the flow of material over the friction surfaces of the refiner tools and/or vice versa the discharge of material into the channels of the work surfaces, which are provided for its removal.

As already explained, not providing an additional pump, for example a solids handling pump, besides the water pump, to convey the plastic or respectively the suspension, is possible. Accordingly, it is possible for the device not to have a pump sump. Hence in this case, a hydrodynamic operation is possible. Nor is a large base for such a pump sump required if a pump sump is dispensed with. The plant can be constructed more compactly and even mobile devices are conceivable.

Additionally, a device in hydrodynamic operation is less susceptible to wear and has a greater availability since a solids handling pump does not need to be provided. The transport of the material is simplified.

Moreover, any necessary targeted exertion of influence according to the invention on the input consistency, the cleaning consistency and the output consistency by individual water injection into the corresponding parts of the device enables a targeted temperature control. Thus the water, which is pumped through the outlet pipe, and the water, which is supplied directly to the plastic in the course of the input into the working gap and before entry into the working gap, can be of a different temperature. It is also possible for the water, which is supplied directly to the working gap of the refiner during the cleaning of the plastic in the working gap, and the water, which is pumped through the outlet pipe, to be of a different temperature. Furthermore, it is possible for the water, which is supplied directly to the plastic in the course of the input into the working gap and before entry into the working gap, and the water, which is supplied directly to the working gap of the refiner during the cleaning of the plastic in the working gap, to be of a different temperature. Hence it is possible, for example, to introduce water of different temperatures to all three water inlets, to adjust the input consistency, the cleaning consistency and the output consistency. Of course it is also possible, for example, for water of the same temperature to be introduced at two of the inlets and water of a different temperature at only one of the three inlets. One application is a targeted addition of cold water in the working gap and/or in the outlet pipe. In this way colloid formations can be reduced, so-called hot melts (labelling adhesives) can be better removed and the floatability is improved. Also conceivable is a pre-heating of the plastic to be cleaned, by introducing hot water in the input apparatus and a cooling in the working gap, by introducing cold water into the working gap, in order to further improve the cleaning efficiency.

According to a further embodiment the solid content of plastic to be cleaned in the working gap can be at least 5% by weight in relation to the water located in the working gap, preferably at least 10% by weight, further preferably more than 10% by weight. For example, with a total weight of the suspension in the working gap of 100 kg, with this embodiment at least 5 kg, preferably at least 10 kg, further preferably more than 10 kg, solid content of plastic to be cleaned (that is, plastic with contaminations still adhering to it) is thus provided. A maximum of 95 kg, preferably a maximum of 90 kg, further preferably less than 90 kg of water is provided accordingly. Hence, with this embodiment, a medium to high consistency operation is realised in the working gap.

According to a further embodiment such a quantity of water can be pumped by means of the water pump through the outlet pipe that the solid content of cleaned plastic and contaminations, such as cellulose and other adhering materials rubbed off in the working gap, is 3% by weight or less in the outlet pipe, in relation to the water located in the outlet pipe. For example, with a total weight of the suspension in the outlet pipe of 100 kg, a maximum solid content of cleaned plastic and the contaminations rubbed off the plastic (cellulose and other adhering materials) of 3 kg is provided. Accordingly, a water content of at least 97 kg is provided. Consequently a low consistency operation is realized in the outlet.

The method according to the invention can be carried out with the device according to the invention. Accordingly the device according to the invention is suitable for carrying out the method according to the invention.

### BRIEF DESCRIPTION OF THE DRAWINGS

An exemplary embodiment of the invention is explained in greater detail below with reference to figures. Schematically,

FIG. 1 shows a part of a device for cleaning plastic according to the invention in a perspective view,

FIG. 2 shows the image from FIG. 1 in a view from the front, and

FIG. 3 shows a vertical section through the image shown in FIG. 1.

### DETAILED DESCRIPTION OF THE INVENTION

If not otherwise specified, the same reference numbers indicate the same objects in the figures. The device according to the invention for cleaning plastic, in particular shredded plastic, in the course of plastic recycling comprises in the example shown a disc refiner 10 with a housing 12 and a first refiner disc 14, which is rotationally mounted around its axis in the housing 12 and rotationally driven by means of a rotary drive (rotor) (not shown in greater detail). The refiner disc 14 has a circular, ring-shaped work surface, on which a plurality of teeth 16 are formed in the example shown. Furthermore, the disc refiner has a second refiner disc which is not shown in the figures for reasons of clear illustration. It has a work surface corresponding to the circular, ring-shaped work surface of the first refiner disc 14, which, in the installed state, faces the work surface of the first refiner disc 14. Between each other the work surfaces accordingly delimit a circular, ring-shaped working gap. The work surface of the second refiner disc can be formed identically to the work surface of the first refiner disc. The second refiner disc can be fixedly arranged in the housing 12 (stator). So, in this case it is a disc refiner which is equipped with toothed discs as refiner tools. Although the invention is explained with reference to a disc refiner in the following, an application is also possible with other refiners, for example conical refiners or drum refiners.

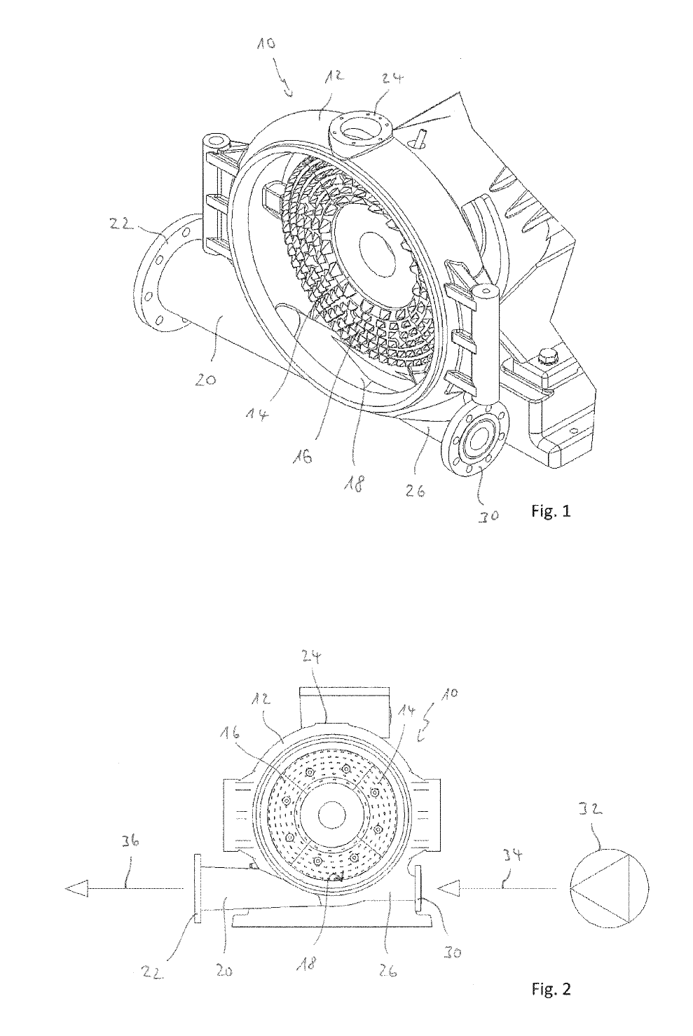

In the example shown, the disc refiner 10 has further an inlet (not shown in greater detail in the figures), which opens into the working gap in the direction of the axis of rotation of the rotationally driven refiner disc 14. Connected to the inlet is an input apparatus, for example a screw conveyor, for inputting the plastic to be cleaned together with water for example. In the example shown in FIG. 2, the input takes place into the plane of the drawing. Furthermore, close to the reference number 18 in FIG. 1 an outlet opening can be seen, which is provided on the downside and lateral relative to the working gap and via which plastic cleaned in the working gap can be conveyed to an outlet pipe 20 which is itself connected to the outlet opening 18 tangentially relative to the working gap. The outlet pipe 20 is directly connected, via a flange 22 or via an additional pipe, to a separation apparatus (not shown), in which the cleaned plastic is separated from the cellulose and other adhering materials, which have been rubbed off in the working gap. It should be noted that the additional inlet 24 shown in the figures is optionally provided in the working gap and can be closed for example.

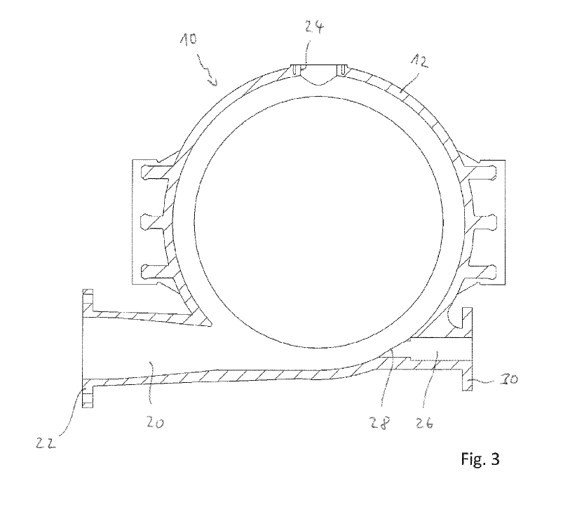

In the example shown a nozzle pipe 26 is connected to the housing 12 and the outlet pipe 20 via a water inlet opening 28 (see FIG. 3) on an end of the outlet pipe 20 which faces away from the flange 22 or respectively the separation apparatus. The nozzle pipe 26 can be directly connected to a water pump 32, for example a centrifugal pump, shown in FIG. 2 via a flange 30 or via an additional pipe.

During the operation of the device according to the invention a suspension of water and plastic to be cleaned, for example shredded plastic to be cleaned, is input into the working gap of the disc refiner 10 through the inlet via the input apparatus. The first refiner disc 14 is rotationally driven and the plastic to be cleaned is cleaned between the work surfaces of both refiner discs. Cellulose and other adhering materials are rubbed off the surface of the plastic by the teeth 16 in particular. This enables operation with a medium to high consistency, that is, the solid content of plastic to be cleaned can be 10% by weight or more in relation to the water in the working gap. In this case it is also possible to supply water directly into the working gap via a suitable water supply apparatus, so that the cleaning consistency in the working gap can be changed in comparison with the input consistency in the input apparatus. It is also possible to influence the process in a suitable manner by targeted temperature control of the water supplied to the working gap.

Together with the rubbed-off cellulose and other adhering materials and the water, the plastic cleaned in the working gap reaches the outlet pipe 20 via the outlet opening 18 by means of centrifugal force. At the same time, during operation, the water pump 32 (shown in FIG. 2) brings a directed water jet through the nozzle pipe 26 in the conveying direction of the suspension, which is exiting the working gap, to the separation apparatus through the water inlet opening 26 into the outlet pipe 20, as illustrated in FIG. 2 by the reference number 34. Hence the directed water jet, like the outlet pipe 20, runs tangentially relative to the working gap. The water jet further transports the mixture of water, cleaned plastic and rubbed-off contaminations located in the outlet pipe 20 to the separation apparatus, as illustrated in FIG. 2 by the reference number 36. In this context the water jet has a suction effect on the working gap according to the principle of a water jet pump in such a way that the suspension of cleaned plastic, rubbed-off contaminations and water is sucked out of the working gap into the outlet pipe 20. Thus the output consistency is adjusted in a suitable manner by the water jet in the outlet pipe 20 at the same time. For example, the solid content of cleaned plastic and rubbed-off contaminations can be 3% by weight or less in relation to water present in the outlet pipe 20. It is also possible to influence the process in a targeted manner in the area of the outlet as well, by suitable temperature control of the water jet. No additional conveying apparatus, for example a solids handling pump, is required for the input, besides the water pump 32 and the screw conveyor. Not even a pump sump is required.

Hence, with the device according to the invention or respectively the method according to the invention, hydrodynamic operation with high cleaning consistency and at the same time low output consistency is possible.

1. (canceled)

2. A device for cleaning plastic comprising:
a housing defining an inlet opening and an outlet;
a first refiner tool disposed within the housing;
a second refiner tool disposed within the housing, the second refiner tool configured to face the first refiner tool;
a working gap defined between the first and second refiner tools and the housing;
an input apparatus configured to couple to the inlet opening; and
a water pump configured to coupled to the outlet, wherein the inlet opening and the outlet are connected to the working gap.

3. The device according to claim 2, wherein the outlet includes an outlet pipe configured to connect to the working gap at one end.

4. The device according to claim 3, wherein a nozzle is coupled to an opposite end of the outlet pipe, the nozzle configured to generate a directed water jet in the outlet pipe.

5. The device according to claim 4, wherein a nozzle pipe acting as a nozzle is inserted into the end of the outlet pipe connected to the water pump.

6. The device according to claim 2, wherein the refiner tools are refiner discs.

7. The device according to claim 6, wherein the inlet opens into the working gap in an axial direction in relation to the refiner discs.

8. The device according to claim 2, wherein the input apparatus comprises a screw conveyor.

9. The device according to claim 2, wherein the input apparatus comprises a water supply apparatus.

10. The device according to claim 9, wherein the water supply apparatus is configured to supply water into the working gap.

11. A method for cleaning plastic using a refiner having two refiner tools configured to facing each other and define a working gap, and wherein at least one of the two refiner tools is rotationally driven, the method comprising:
feeding plastic to be cleaned into the working gap;
rubbing off cellulose and other adhering materials; and
moving the cleaned plastic and the rubbed-off cellulose and other adhering materials out of the working gap through an outlet by a suction force created in the working gap by a water pump pumping water through an outlet pipe connected to the working gap to the outlet.

12. The method according to claim 11, wherein the refiner is a disc refiner.

13. The method according to claim 11, wherein the plastic to be cleaned is input into the working gap via a screw conveyor.

14. The method according to claim 11, wherein water is supplied directly to the working gap of the refiner during cleaning of the plastic in the working gap.

15. The method according to claim 14, wherein the water supplied directly to the working gap of the refiner during cleaning of the plastic in the working gap is at a different temperature than the water pumped through the outlet pipe.

16. The method according to claim 11, wherein a solid content of plastic to be cleaned in the working gap is at least 5% by weight in relation to water located in the working gap.
